(19) United States
(12) Patent Application Publication
(10) Pub. No.: US 2013/0278006 A1
(43) Pub. Date: Oct. 24, 2013

(54) Vertical sun visor extender

(71) Applicants: Eloy Sanchez, Edinburg, TX (US); Jacquelyn Sanchez, Edinbury, TX (US)

(72) Inventors: Eloy Sanchez, Edinburg, TX (US); Jacquelyn Sanchez, Edinbury, TX (US)

(21) Appl. No.: 13/986,202

(22) Filed: Apr. 11, 2013

Related U.S. Application Data
(60) Provisional application No. 61/687,109, filed on Apr. 18, 2012.

(51) Int. Cl. B60J 3/02

(52) U.S. Cl. CPC B60J 3/0208
USPC 296/97.6

(57) ABSTRACT

A vertical sun blocking apparatus that straps on to the vehicle's factory sun visor. To strap on our apparatus on the factory sun visor the user should preferably be seating in the vehicle's seat, facing the windshield with the factory sun visor in a down position. Then take our sun blocking apparatus with the extender panel #21 facing the user, wrap the tension strap #22 around the factory sun visor with the attached part of the cardboard extender panel #21 and the tension strap #22 to the top. Pull the hook fastener #23A and loop fastener #23B ends together to create a band around the factory sun visor, leaving the cardboard extender panel #21 free to extend downward to block the sun when the user wants to use it, whether on the side door window or windshield side. When the user wants to use the apparatus, pull the cardboard extender panel #21 from the store position to the operating position. Pulling on the tension strap #22 down will bring the cardboard extender panel #21 up into the store position on the opposite side of the factory sun visor and pulling up the tension strap #22 will extend down the cardboard extender panel #21 on the opposite side of the factory sun visor. The same can be accomplished by pulling up or down on the cardboard extender panel #21. The user can adjust the amount of the apparatus extending below the factory sun visor, as well as adjust the apparatus horizontally on the factory sun visor. The user can remove the apparatus by undoing the hook fastener #23A and the loop fastener #23B ends.

### BACKGROUND

The standard factory sun visors in automobile's currently in use do extend horizontally, but not vertically, which when the factory sun visors are turned down facing the windshield, or down and outward to cover the side door windows, it still leaves the problem area that the factory sun visors do not cover, specifically in the morning sunrise or afternoon sunset. See FIGS. 1 and 10.

### SUMMARY

We've invented a vertical sun visor extender. Our vertical sun visor extender straps on vertically around the factory sun visors of automobiles and other similar vehicles. See FIG. 2.

In operating position our vertical sun visor extender is made to block the sun on the windshield side and the side of the user's face. See FIGS. 3, and 10.

### Advantages

Others have invented other vertical sun visors extenders but our vertical sun visor extender is better because:
it is amberdextras and can be used by itself or in multiples, side by side or back to back
it is light weight
once it is strapped on it can be operated with one hand to keep the other hand on the user's steering wheel while driving
it is not awkward or cumbersome to use or handle
it does not require big clamps, and can co-exist with garage door opener, and factory sun visor mirror
it is simple to make, install, use, and remove
it easily adjusts to different factory sun visors sizes
it easily adjusts to different vertical levels as needed and easily adjusts to different horizontal positions on the factory sun visors
it can incorporate decorative designs, advertising, or logos
it is ecological, and biodegradable.

### DRAWINGS—FIGURES

FIG. 1. Is a side view showing the sun in a person's face problem area that the factory sun visor does not cover.

FIG. 2. Is a side view showing our vertical sun visor extender strapped on to a factory sun visor in the store position.

FIG. 3. Is a side view showing our vertical sun visor extender strapped on to a factory sun visor in the fully extended position.

FIG. 4. Is a perspective view showing our vertical sun visor extender.

FIG. 5. Front view of our vertical sun visor extender.

FIG. 6. Back view of our vertical sun visor extender.

FIG. 7. Section view of our vertical sun visor extender.

FIG. 8. Section view showing a factory sun visor with our vertical sun visor extender strapped on, in the store position.

FIG. 9. Section view showing a factory sun visor with our vertical sun visor extender strapped on, in the fully extended position.

FIG. 10. Horizontal view showing a windshield and factory sun visors with our vertical sun visor extenders strapped on, in the store position and in the fully extended position.

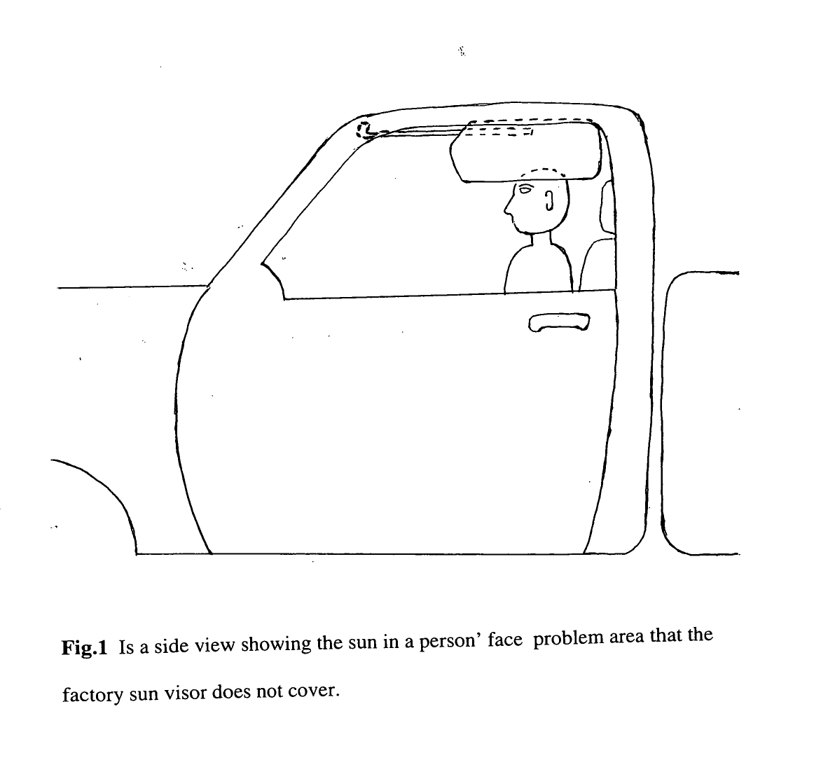

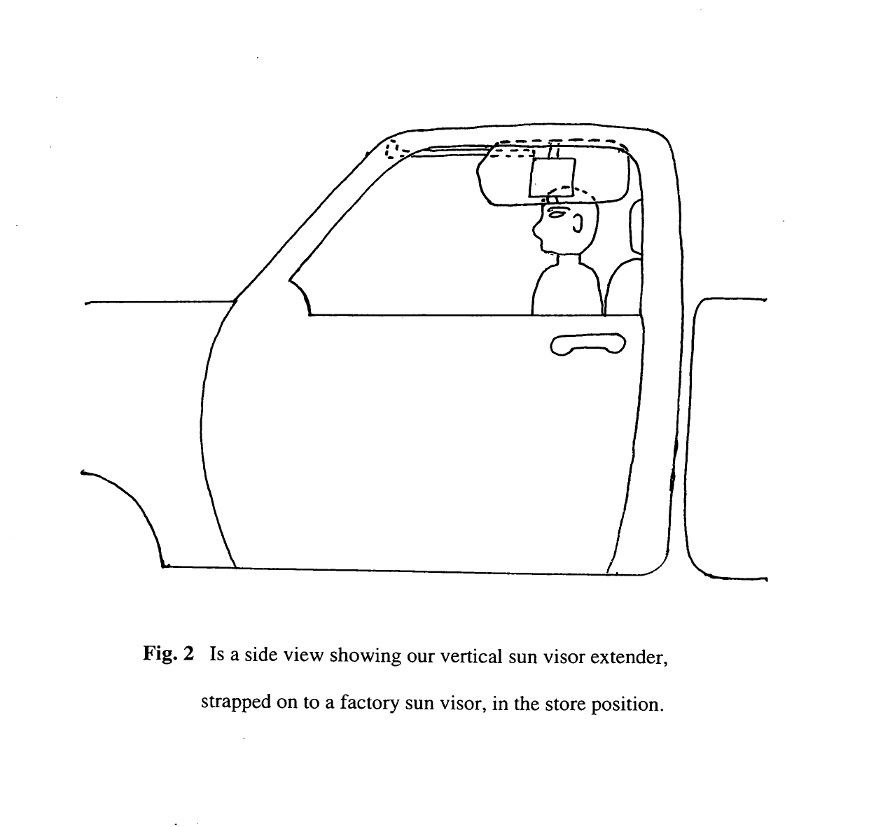

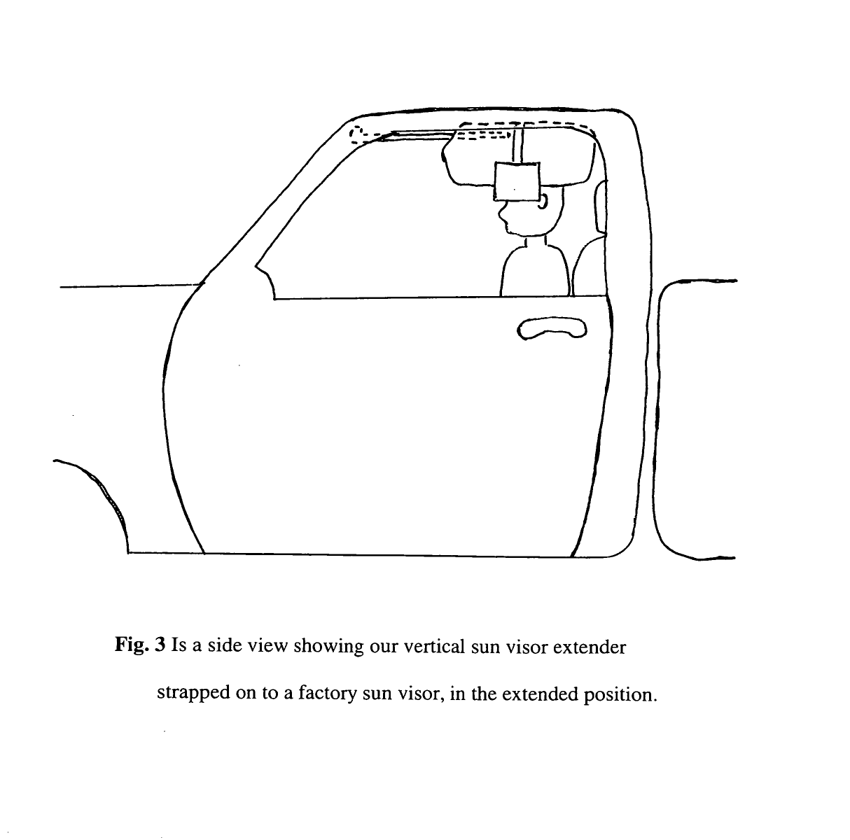

### DETAIL DESCRIPTION

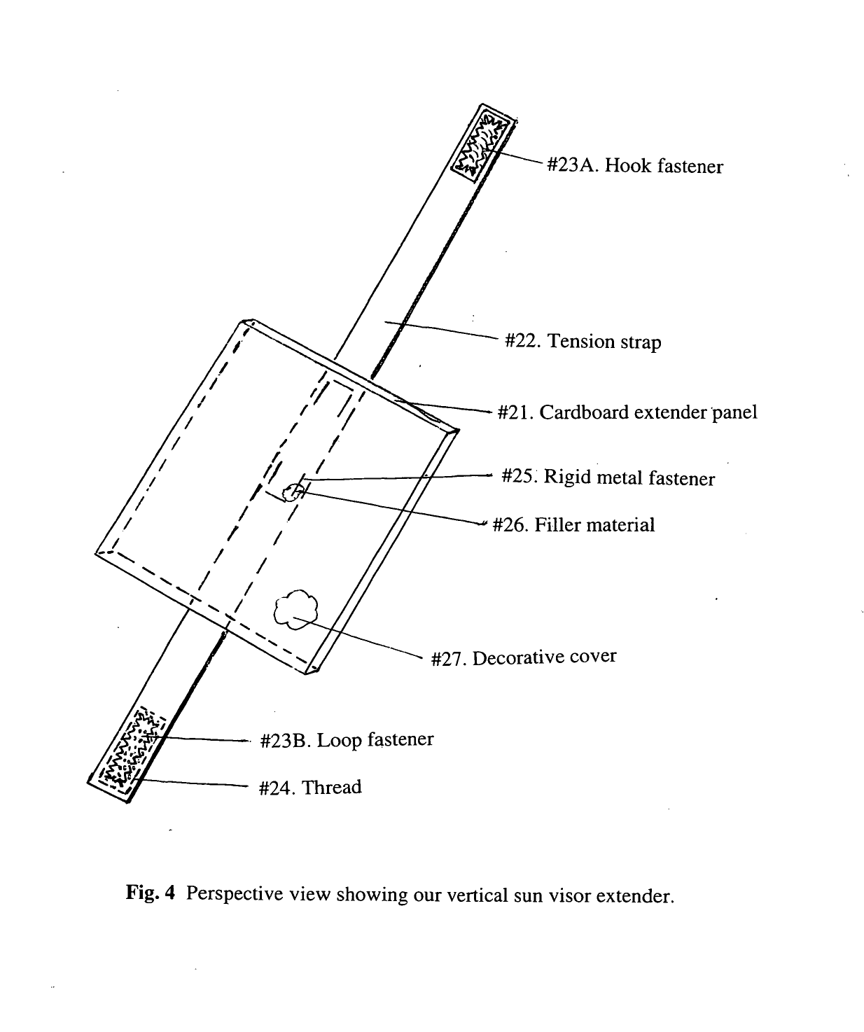

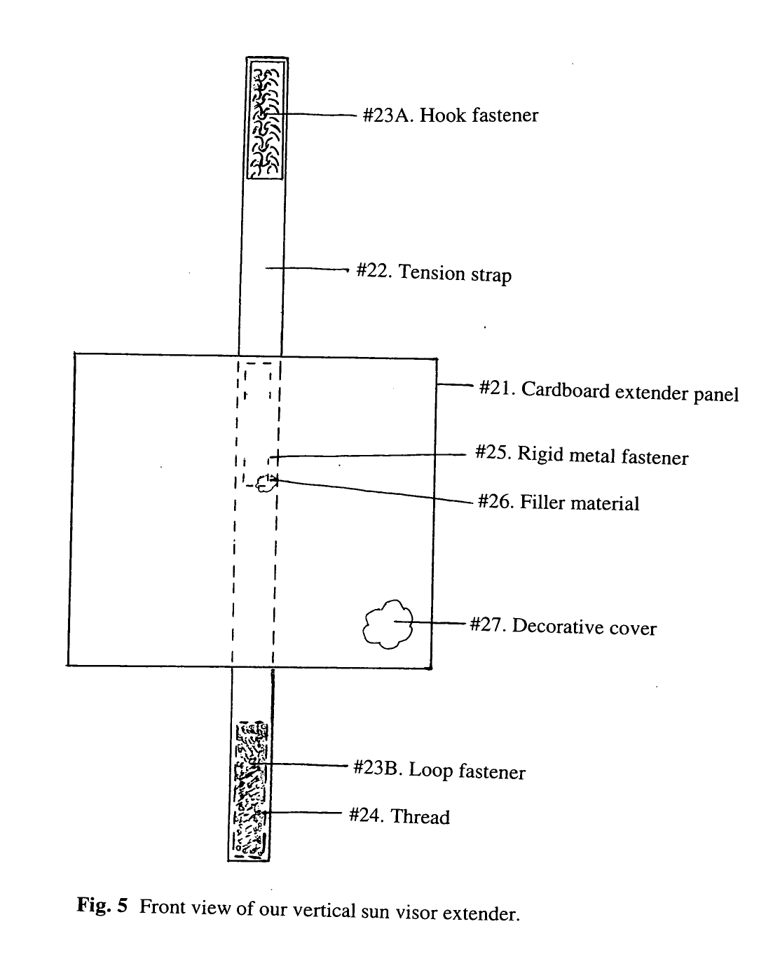

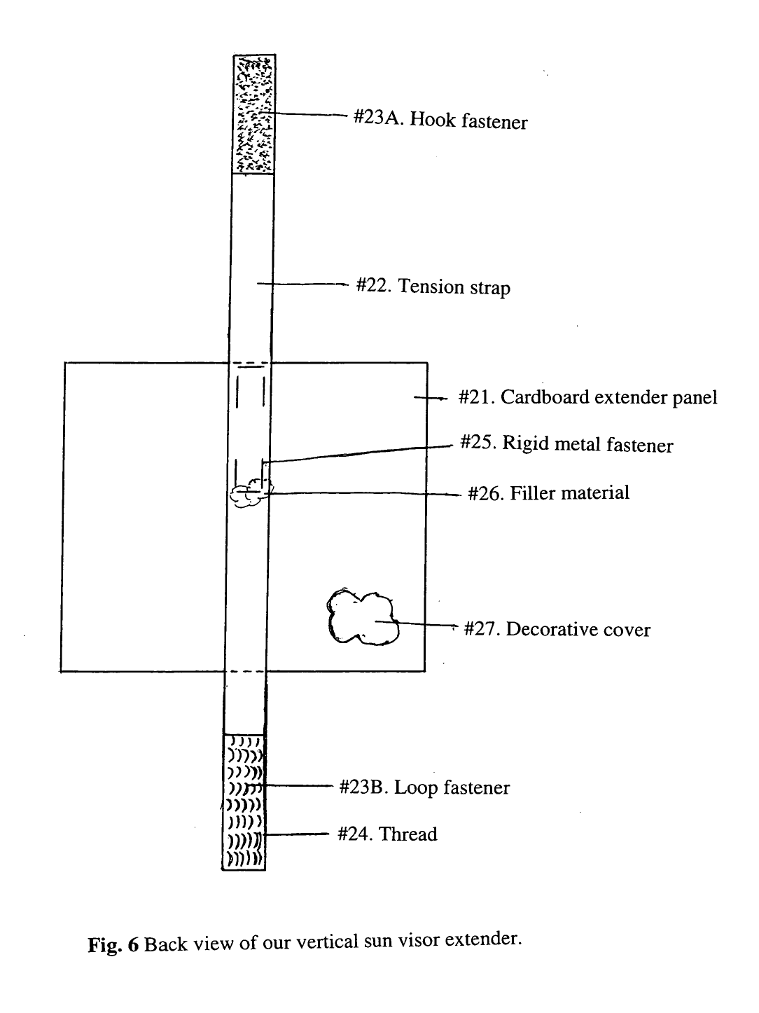

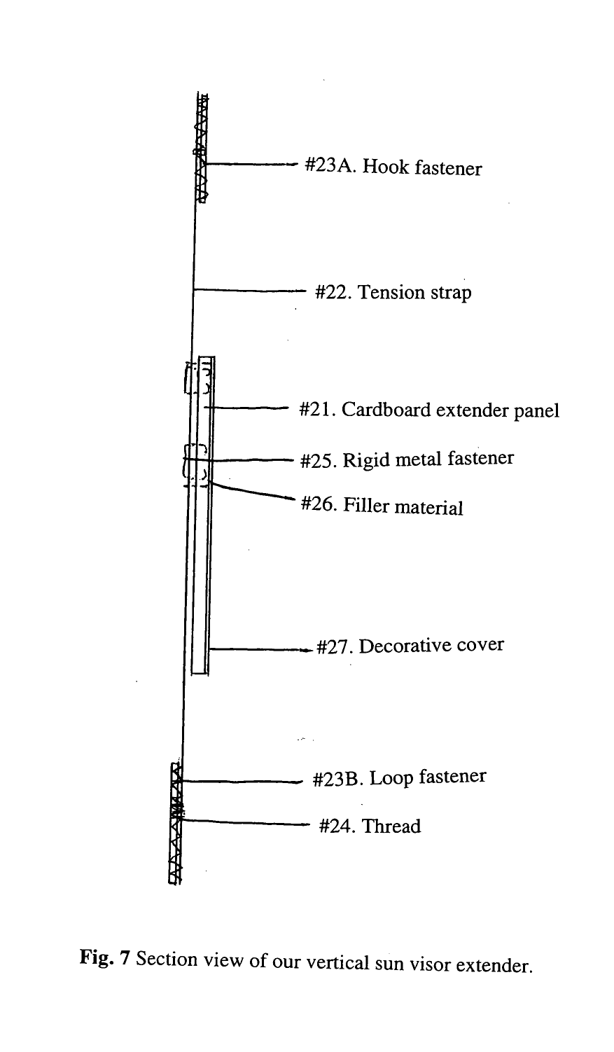

Our vertical sun visor extender is made up of a cardboard extender panel #21, a tension strap #22, which at the top front has a hook fastener #23A and loop fastener #23B to the bottom back side attached with thread #24, to make a band around the factory sun visor once the hook #23A and loop #23B fasteners are married. The cardboard extender panel #21 and the tension strap #22 are attached with rigid metal fasteners #25 on the top half and center of the cardboard extender panel #21, to the top center half of the tension strap #22. The rigid metal fasteners' #25 indentions on the face of cardboard extender panel #21 are covered with filler material #26 before the cardboard extender panel #21 is covered with a decorative cover #27. See FIGS. 4, 5, 6, and 7.

### Operational

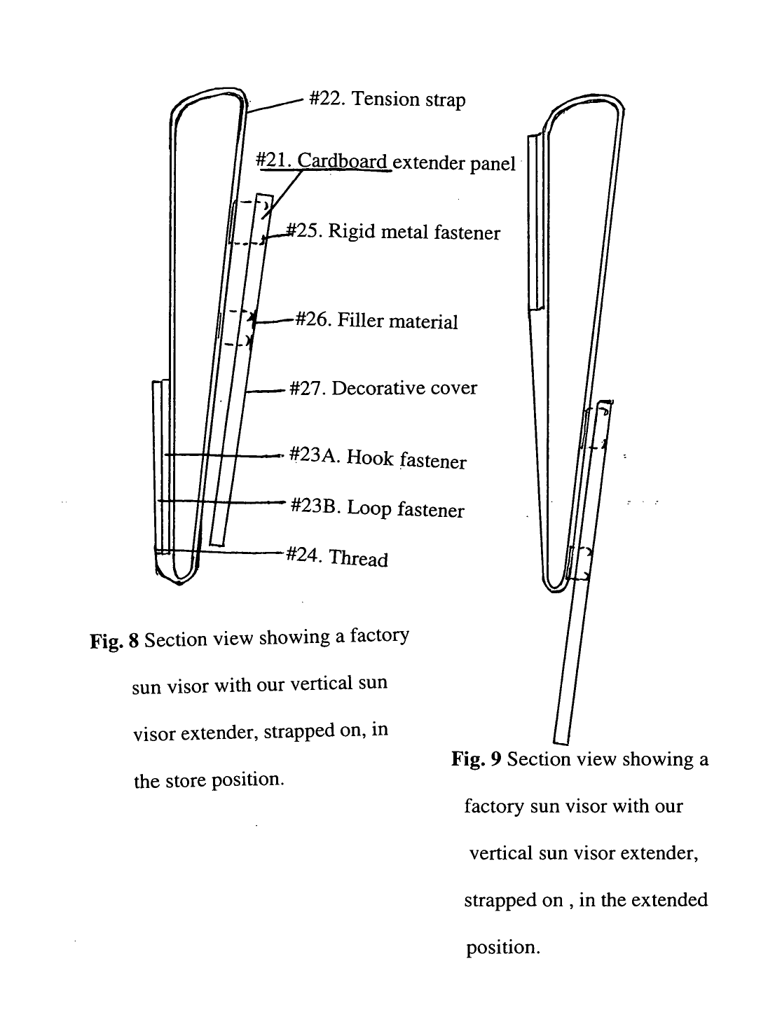

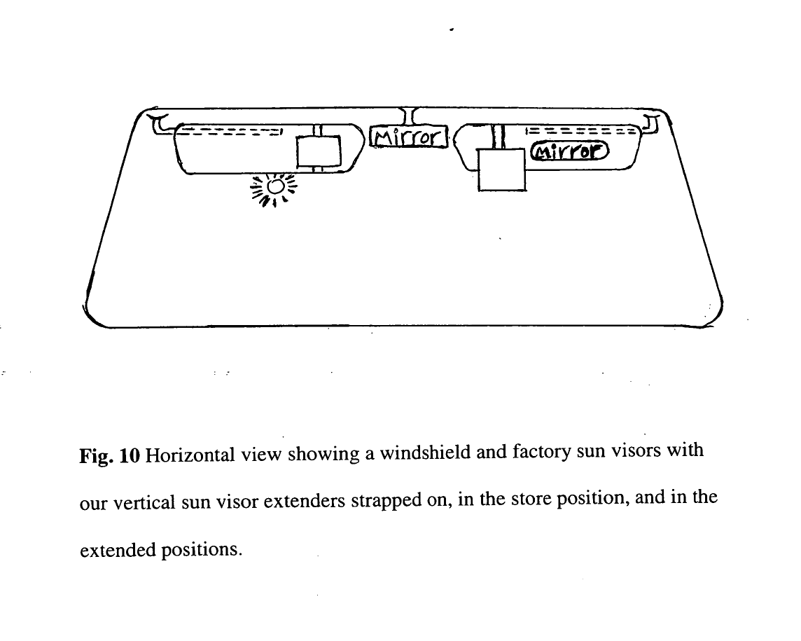

The cardboard extender panel #21 does the sun blocking as well as provide a backing for the decorative cover #27. The tension strap #22 which has a hook fastener #23A sewed on with thread #24 on the top, front side of the tension strap #22 and a loop fastener #23B sewed on with thread #24 on the bottom, back side of the tension strap #22 straps in place by overlapping and marrying the hook fastener #23A and loop fastener #23B ends, around the factory sun visor. Using the tension strap #22 with the hook fastener #23A as the top, place the top of the cardboard extender panel #21 right around the half way point, length wise on the tension strap #22, only the vertical top half, and horizontal center of the cardboard extender panel # 21 is attached to the tension strap # 22 with rigid metal fasteners #25. having attached only half of the cardboard extender panel # 21 to the tension strap #22 allows for the tension strap #22 to spin around the factory sun visor and the unattached part of the cardboard extender panel #21 to extend below the factory sun visor into operating position and until the attached part of the cardboard extender panel #21 stops the spin. The rigid metal fasteners #25 are inserted with a rigid metal fastener gun from the tension strap #22 side and cross the cardboard extender panel #21 until the rigid metal fasteners #25 are curved. back into the cardboard extender panel #21, leaving raised curved rigid metal fasteners #25 on the cardboard extender panel #21. The raised rigid metal fasteners # 25 ends are set into the cardboard extender panel #21 by clamping down on the raised rigid metal fasteners #25 with a C-clamp vise grip pliers which leaves indentations at every rigid metal fastener #25 end. The indentations are filled with 2 coats of filler material #26, before the decorative cover #27 goes on the cardboard extender panel #21. Our vertical sun visor extender is made to strap on vertically and snugly enough over the factory sun visor to stay in place yet comfortable enough to allow the tension strap #22 to spin around the factory sun visor by adjusting the tension on the tension strap #22 when marring the hook fastener #23A to the loop fastener #23B ends at the desired length. Our vertical sun visor extender is made to be strapped on the factory sun visor, keeping the attached portion of the sun visor extender to the top of the factory sun visor, with the cardboard extender panel #21 facing the user on the near side of the factory sun visor or can also be strapped on the far side of the factory sun visor facing away from the user. Our vertical sun visor extender can be operated by pulling the tension strap #22 or by pulling the cardboard extender panel #21, either up into the store position or down into the sun blocking position. See FIG. 8.

### Ramifications

While the above description contains many specifics these should not be construed as limitations on the scope See FIG. 9. of any embodiment, but as exemplifications of the presently embodiments thereof. Many other ramification and variations are possible within the teachings of the various embodiments.
Our vertical sun visor extender blocks the sun at the front windshield side where the factory sun visor does not cover in the morning's sun rise and afternoon's sunsets,
It is amberdexterous and can be used by itself or in multiples
It is light weight
Once strapped on, it can be operated with one hand, to keep the other hand on the steering wheel
It is simple to make, install, use, and remove
It easily adjusts to different factory sun visor sizes
It easily adjusts to different levels of position vertically, and adjusts to different areas horizontally on the factory sun visor
No big clamps, can co-exists with garage door openers, and factory sun visor mirrors
Easily can incorporate decorative logos or different compositions of the user's choice according to preference and life style
It is biodegradable, ecological
Add a strap and make it wider and longer
The extender panel can be of transparent colors
The extender panel can be made of cardboard, plastic, or another material
The extender panel can be of different shapes and sizes
The extender panel and the tension strap can be attached with snap on clips or hook and loop fasteners
The tension strap can be made of different colors and shapes
The tension strap can be made of cloth like materials
A factory sun visor can be modified to fit inside it, our vertical sun visor extender

Our vertical sun visor extender also comprises such other objects, advantages, and capabilities as will later more fully will appear, and which are inherently possessed by it, therefore, the scope of our invention should be determined by the claims and their legal equivalents, and not by the examples given.

### Embodiment

The preferred embodiment selected to illustrate our vertical sun visor extender comprises of FIG. 4 It is to be understood that the same is susceptible of modification and change without departing from the spirit of our vertical sun visor extender, some are:
the extender panel can be of transparent colors
add another tension strap and make wider
attach the extender panel to the tension strap using snap on clips

What is claim is a vertical sun visor extender comprising,

1. A tension strap
a. wherein said tension strap has a top end a bottom end a front side and a back side
b. Wherein said tension strap has a hook fastener attached with thread on the top end front side
c. Wherein said tension strap has a loop fastener attached with thread on the bottom end back side
d. Wherein said tension strap is long enough in length to wrap around and overlap the hook and loop ends around the factory sun visor.
e. Wherein said tension strap is long enough to wrap around the factory sun visor and the hook and loop fastener ends overlap and attach
f. Wherein said tension strap, includes the means to strap around said factory sun visor
g. Wherein said tension strap, provides means of vertical rotation around said factory sun visor
h. Wherein said tension strap, provides the means to attach said extender panel with rigid metal fasteners

2. An extender panel
a. Wherein said extender panel has a top front
b. Wherein said extender panel has a vertical and horizontal center
c. Wherein said extender panel fits within the perimeter of said factory sun visor yet sufficient in size to block out the sun
d. Wherein said extender panel adjusts to different extended operating positions
e. Wherein said extender panel provides a means to pull said extender panel into a store position or operating positions
f. Wherein said extender panel provides the means to block the sun of the user's eyes

3. A fastening system
a. Wherein said extender panel attaches on the said tension strap with rigid metal fasteners
b. Wherein said method of attaching the extender panel and the tension strap, comprises
c. Wherein said step of installing rigid metal fasteners across the tension strap at the half way point and the top half and center of the cardboard extender panel
d. Wherein said method provides the means for the card board extender panel to extend downwards until the attached part of tension strap and the cardboard extender panel gets to the bottom of the vehicle's factory sun visor
